(19) United States
(12) Patent Application Publication
(10) Pub. No.: US 2008/0304279 A1
(43) Pub. Date: Dec. 11, 2008

(54) DISCHARGE LAMP LIGHTING UNIT

(75) Inventors: Naoki Sugiura, Shizuoka-shi (JP); Masayasu Ito, Shizuoka-shi (JP)

Correspondence Address: SUGHRUE-265550, 2100 PENNSYLVANIA AVE. NW, WASHINGTON, DC, 20037-3213, US

(73) Assignee: KOITO MANUFACTURING CO., LTD., Tokyo (JP)

(21) Appl. No.: 12/133,779

(22) Filed: Jun. 5, 2008

(30) Foreign Application Priority Data
Jun. 6, 2007 (JP) 2007-150806

(51) Int. Cl. B60Q 1/02; B60Q 1/00

(52) U.S. Cl. 362/538; 315/82

(57) ABSTRACT

A discharge lamp lighting unit and vehicle headlamp are provided. The discharge lamp lighting unit includes a case body comprising a fitting portion and a projection portion, the fitting portion and the projection portion arranged in an L-shaped configuration, the discharge lamp being connected to the discharge lamp lighting unit at the fitting portion of the case body, and the projection portion projecting in the emergent light direction alongside of the discharge lamp; and a plurality of lighting circuit components, at least one of which is arranged in the projection portion. The vehicle headlamp includes a lamp unit which includes a discharge lamp which emits light, a reflector which reflects the light from the discharge lamp in an emergent light direction, and a holding projection which is provided at an end of the reflector at which the discharge lamp is mounted; and the discharge lamp lighting unit.

This application claims priority from Japanese Patent Application No. 2007-150806, filed Jun. 6, 2007, in the Japanese Patent Office. The Japanese Patent Application No. 2007-150806 is incorporated by reference in its entirety.

### TECHNICAL FIELD

Apparatuses and devices consistent with the present disclosure relate to discharge lamps and, more particularly, to discharge lamps which obtain a downsizing by using an alignment space effectively.

### RELATED ART

In related art vehicle lighting equipment, for example, a vehicle headlight, a related art discharge lamp lighting unit for executing lighting control of a discharge lamp used as a light source is provided.

The related art discharge lamp lighting unit is constructed by aligning predetermined respective portions in the interior of the case body, as shown in, for example, Japanese Patent Application Publication No. 2003-22702. The respective portions include, for example, a lighting circuit portion, etc., for example, a power supplying portion having a switching element for supplying power to the discharge lamp, a controlling portion for controlling the power supplied to the discharge lamp, a high-voltage generating portion called a starter for lighting the discharge lamp by generating a high voltage in the discharge lamp, etc.

In the related art vehicle headlight set forth in Japanese Patent Application Publication No. 2003-22702, a case body of the discharge lamp lighting unit is formed as a substantially rectangular prism, and a socket connected to the discharge lamp is fitted to a front surface portion of the case body. Therefore, the whole discharge lamp lighting unit is positioned immediately behind the discharge lamp, and the discharge lamp, the socket, and the discharge lamp lighting unit are arranged in order from the front side.

However, vehicle downsizing is becoming increasingly popular, particularly the downsizing in the longitudinal direction of vehicle lighting equipment. In the related art vehicle headlight described in Japanese Patent Application Publication No. 2003-22702, for example, the whole discharge lamp lighting unit is arranged immediately behind the discharge lamp. Accordingly, there is a disadvantage in that an alignment space of the discharge lamp lighting unit is large in the longitudinal direction, and therefore the alignment space prevents the downsizing of the vehicle headlight.

Additionally, in the related art vehicle headlight, various electrical components of the related art discharge lamp lighting unit are connected using electrical wire. This type of connection creates another disadvantage in that, in the vehicle headlight and the discharge lamp lighting unit, as the space in which the discharge lamp lighting unit is housed is downsized, the connections between electrical components becomes more difficult to make, and the electrical wire connecting the components must be compressed into an increasingly smaller space, potentially causing damage to the electrical wiring and the discharge lamp lighting unit.

### SUMMARY

Accordingly, it is an aspect of the present invention to provide a discharge lamp lighting unit which can attain a downsizing of the vehicle lighting equipment.

Exemplary embodiments of the present invention address the above disadvantages and other disadvantages not described above. However, the present invention is not required to overcome the disadvantages described above, and thus, an exemplary embodiment of the present invention may not overcome any of the problems described above.

According to an exemplary embodiment of the present invention, there is provided a discharge lamp lighting unit which includes a case body having a fitting surface portion to which the discharge lamp or a socket for connecting the discharge lamp is fitted and which is directed in a fitting direction of the discharge lamp or the socket; and a lighting circuit portion arranged in the case body, for lighting the discharge lamp; wherein a projection portion projected from the fitting surface portion toward the discharge lamp side in the fitting direction and positioned in vicinity of a reflector is provided in the case body, and at least a part of parts comprising the lighting circuit portion is arranged in the projection portion.

According to another exemplary embodiment of the present invention, there is provided a discharge lamp lighting unit for lighting a discharge lamp, the discharge lamp lighting unit comprising a case body comprising a fitting portion and a projection portion, the fitting portion and the projection portion arranged in an L-shaped configuration, the discharge lamp being coupled to the discharge lamp lighting unit at the fitting portion of the case body, and the projection portion projecting in the emergent light direction alongside of the discharge lamp; and a plurality of lighting circuit components, at least one of the lighting circuit components being arranged in the projection portion.

According to yet another exemplary embodiment of the present invention, there is provided a vehicle headlamp comprising a lamp unit and a discharge lamp lighting unit. The lamp unit comprises a discharge lamp which emits light, a reflector which reflects the light from the discharge lamp in an emergent light direction, and a holding projection which is provided at an end of the reflector at which the discharge lamp is mounted. The discharge lamp lighting unit comprises a case body comprising a fitting portion and a projection portion, the discharge lamp being coupled to the discharge lamp lighting unit at the fitting portion of the case body, and the projection portion projecting in the emergent light direction alongside of the holding projection of the lamp unit; and a plurality of lighting circuit components, at least one of the lighting circuit components being arranged in the projection portion.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is a schematic longitudinal sectional view of a vehicle lighting equipment equipped with a discharge lamp lighting unit according to an exemplary embodiment of the present invention;

FIG. 2 is a conceptual view showing a space formed on an outer surface side of a reflector when viewed from a back surface side of a lamp unit;

FIG. 3 is an enlarged sectional view showing the discharge lamp lighting unit of FIG. 1 in a state in which a socket is fitted;

FIG. 4 is a block diagram showing a lighting circuit portion of the discharge lamp lighting unit of FIG. 1;

FIG. 5 is a conceptual view showing an alignment position of a switching element of the discharge lamp lighting unit of FIG. 1;

FIG. 6 are views showing an example in which radiating fins are provided on a case body of the discharge lamp lighting unit of FIG. 1, wherein the view on the left side is a schematic sectional view and the view on the right side is a schematic rear view.

FIG. 7 a side view showing respective portions of the space formed on the outer surface side of the reflector of the discharge lamp lighting unit of FIG. 1.

### DETAILED DESCRIPTION OF EXEMPLARY EMBODIMENTS OF THE PRESENT INVENTION

Exemplary embodiments of the present invention will now be discussed with reference to the accompanying drawings.

A vehicle lighting equipment 1 (e.g., a vehicle headlight) is fitted and arranged to left and right end portions of the front end portion of a vehicle body.

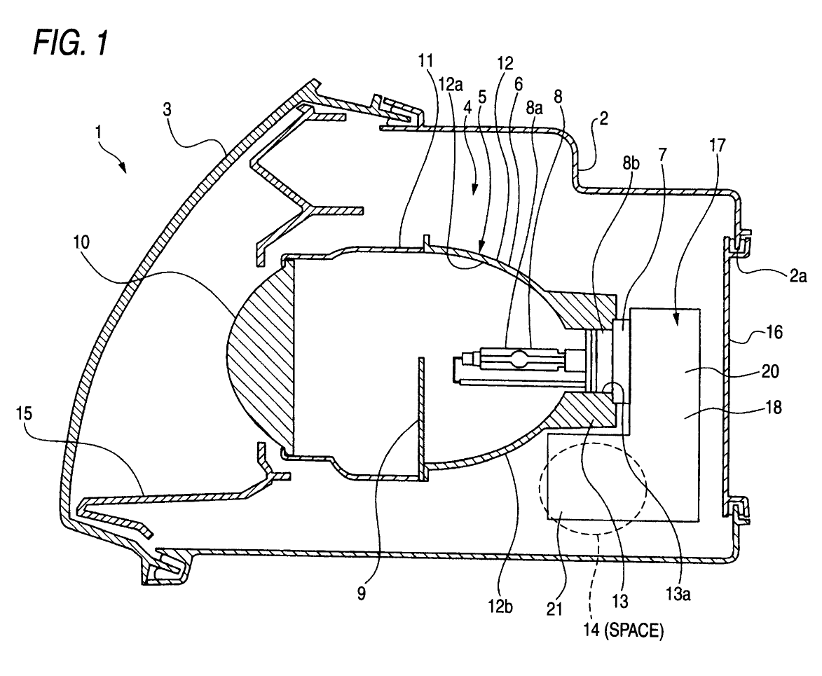

As shown in FIG. 1, the vehicle lighting equipment 1 is equipped with a lamp body 2 having a concave portion that is opened forwardly, and a front cover 3 for covering a front surface of the opening of the lamp body 2. An internal space defined by the lamp body 2 and the front cover 3 is formed as a lighting chamber 4.

A fitting opening 2a passing through longitudinally is formed in the rear end portion of the lamp body 2.

A lamp unit 5 is arranged in the lighting chamber 4. The lamp unit 5 is supported by a supporting mechanism (not shown) such that the lamp unit 5 can be tilted with respect to the lamp body 2 in the horizontal direction and the vertical direction.

The lamp unit 5 has a reflector 6, a socket 7 held at the rear end portion of the reflector 6, a discharge lamp 8 coupled to the socket 7, a shade 9 fitted to the front end portion of the reflector 6, a lens 10 arranged in front of the discharge lamp 8, and a lens holder 11 fitted to the reflector 6 to hold the lens 10.

The reflector 6 has a light reflecting portion 12, and a holding projection 13 provided continuously to the rear end of the light reflecting portion 12. The light reflecting portion 12 is formed like a bowl that is opened forward, and an inner surface of the light reflecting portion 12 is formed as a reflecting surface 12a. The reflecting surface 12a is formed as a paraboloid or an ellipsoid. The holding projection 13 is projected backward from the rear end of the light reflecting portion 12, and is formed like an almost circular cylinder. Therefore, a holding hole 13a that passes through longitudinally is formed in the holding projection 13.

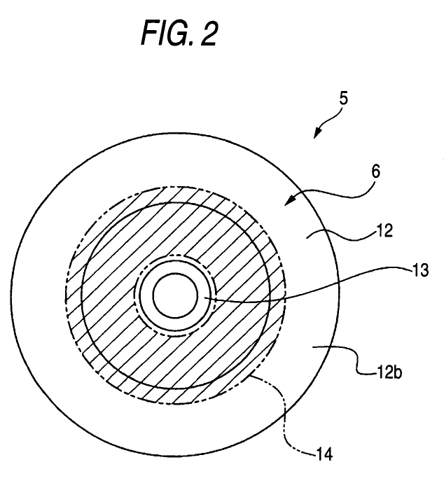

As described above, the reflector 6 comprises the light reflecting portion 12 and the holding projection 13, and the light reflecting portion 12 is formed like a bowl that is opened forward. Therefore, as shown by the shaded region in FIG. 2, a space 14 is formed on the outer peripheral side of the holding projection 13 in the lighting chamber 4.

Returning to FIG. 1, the socket 7 is held by the holding projection 13 in a state that a bulb base 8b is inserted into the holding hole 13a of the reflector 6. Alternatively, the bulb base 8b may be held by the holding projection 13 in a state that a space is formed between the socket 7 and the holding projection 13.

The discharge lamp 8 is coupled to a front surface of the socket 7. The discharge lamp 8 is attached detachably to the socket 7, and the discharge lamp 8 can be removed from the socket 7 as the case may be. As a result, the discharge lamp 8 can be exchanged easily, and an improvement of maintainability can be attained.

The discharge lamp 8 has a light emitting main body 8a in which a light emitting portion (e.g., an arc tube) is sealed in the glass tube, and the bulb base 8b coupled to the socket 7.

The shade 9 is fitted to the front end portion of the reflector 6, and has a function of shading a part of the light that is emergent from the discharge lamp 8.

An extension 15 for blocking a part of the lamp unit 5 is arranged in the lighting chamber 4.

A back cover 16 for closing the fitting opening 2a is fitted to the rear end portion of the lamp body 2.

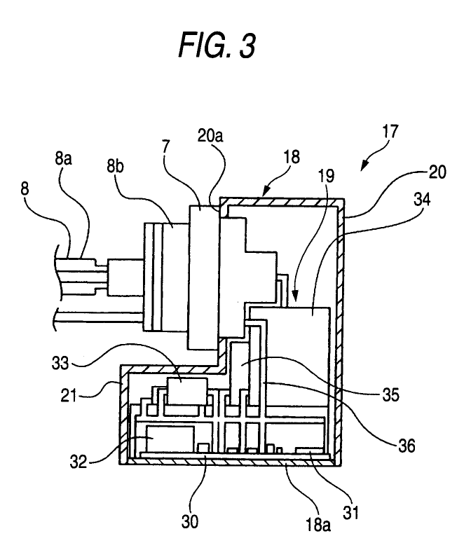

A discharge lamp lighting unit 17 is fitted to the rear end portion of the socket 7 (see FIG.3). Hence, the discharge lamp lighting unit 17 is arranged on the outer surface 12b side as a surface on the opposite side of the reflecting surface 12a of the reflector 6.

As shown in FIG. 3, the discharge lamp lighting unit 17 is constructed by arranging a lighting circuit portion 19, which lights the discharge lamp, in a case body 18.

The case body 18 comprises a main body portion 20, and a projection portion 21 that is projected forward from the main body portion 20. The main body portion 20 is formed like a rectangular prism, for example. The projection portion 21 is also formed like a rectangular prism, for example, and is protruded forward from the lower end portion of the main body portion 20. Inner portions of the main body portion 20 and the projection portion 21 communicate with each other. At least a part of the case body 18, e.g., a bottom surface portion 18a, is formed of the metal material.

As shown in FIG. 1, the main body portion 20 is positioned at the back of the reflector 6, and the projection portion 21 is positioned under the holding projection 13 of the space 14. The front surface portion of the main body portion 20 is provided as a fitting surface portion 20a to which the socket 7 is fitted (see FIG.3). The fitting surface portion 20a is formed such that the fitting surface portion 20a is directed in the longitudinal direction and is directed in the same direction as the connecting direction of the socket 7 and the discharge lamp 8.

The discharge lamp 8 is coupled to the case body 18 via the socket 7 by way of example. Alternatively, the bulb base 8b of the discharge lamp 8 may be fitted to the fitting surface portion 20a such that the discharge lamp 8 is fitted to the case body 18 without the socket 7.

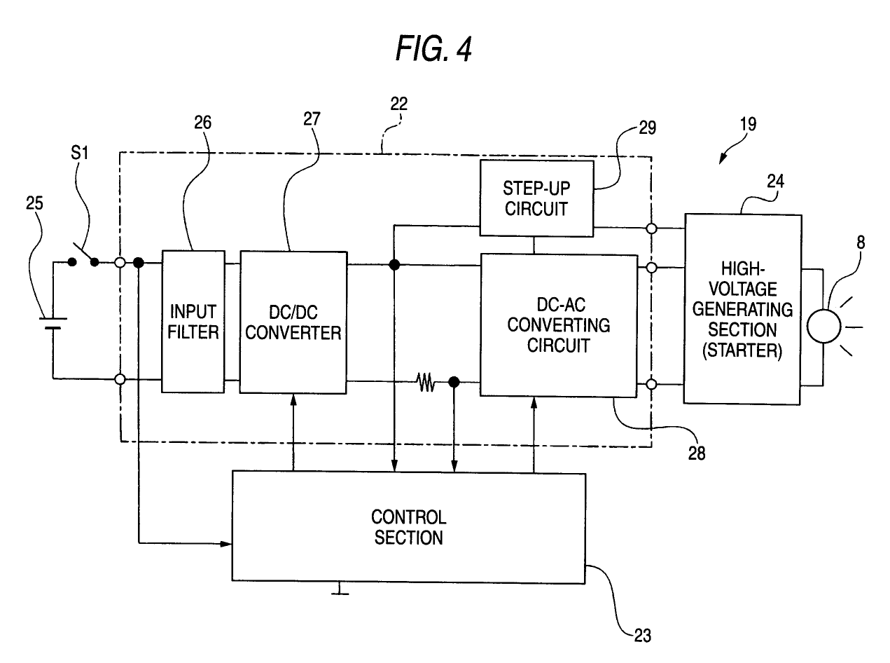

As shown in FIG. 4, the lighting circuit portion 19 comprises a power supplying portion 22 for supplying the power, which is obtained by converting an input DC voltage into another DC voltage by switching the switching element, to the discharge lamp 8; a control section 23 for controlling the power supplied from the power supplying portion to the discharge lamp 8; and a high-voltage generating section 24 called a starter for generating a high voltage in the discharge lamp 8 to light the discharge lamp 8.

An input filter 26 is coupled to a DC power supply 25 via a switch S1. The input filter 26 suppresses noise that is generated in the lighting circuit portion 19 and noise that enters into the lighting circuit portion 19.

A DC/DC converter 27 is coupled to the input filter 26 and acts as a DC-DC converting circuit. The DC/DC converter 27 receives the input DC voltage supplied from the DC power supply 25 via the input filter 26 and steps up the DC voltage to a desired DC voltage.

In the DC/DC converter 27, an internal switching element is driven based on a control signal fed from the controlling portion 23.

A DC-AC converting circuit 28, e.g. a full-bridge inverter, converts an output voltage of the DC/DC converter 27 into an AC voltage (e.g., a rectangular wave), and then supplies the AC voltage to the discharge lamp 8. In the DC-AC converting circuit 28, for example embodied in as a full-bridge inverter, two sets of switching elements pairs are used to form two arms, and a driving circuit for driving the switching elements of respective arms individually is provided. The full-bridge inverter outputs the AC voltage by ON/OFF-controlling two sets of switching elements pairs reciprocally. In the DC-AC converting circuit 28, the internal switching elements are driven by the control signal from the control section 23.

A step-up circuit 29 applies a step-up voltage to the high-voltage generating portion 24. The high-voltage generating portion 24 generates a high-voltage pulse of about 25 kV, for example, in starting the discharge lamp 8.

The control section 23 executes lighting control (e.g., transient/steady power control) of the discharge lamp 8. A fail-safe circuit for detecting an input/output failure and executing an operation stop control is included-in the control section 23.

As shown in FIG.3, the lighting circuit portion 19 is arranged in the main body portion 20 and the projection portion 21 of the case body 18, and a surface mounting substrate 30 is placed in a state that the surface mounting substrate 30 surface-contacts the bottom surface portion 18a formed of the metal material of the case body 18. Small-sized electronic parts such as a switching element 31, a coil 32, a ceramic capacitor, a chip resistor, an integrated IC, etc., for example, are mounted on the surface mounting substrate 30 as respective parts comprising the lighting circuit portion 19. Large-sized electronic parts comprising the lighting circuit portion 19, for example, an electrolytic capacitor 33, a transformer 34, a coil 35, etc. are coupled to the surface mounting substrate 30 via a metal plate 36 (e.g., a bus bar).

Normally the metal plate 36 is a long and narrow rod-like conductor that is used as the power source supply line instead of an electric wire. A sectional shape of the electric wire is a circle, but a sectional shape of the metal plate is shaped into an extremely long and narrow rectangle. Therefore, the metal plate has a high heat radiating performance, and is advantageous to the high-speed system whose surface current is large because a surface area of the metal plate is large. Also, because the metal plate 36 is used as a conductor, the wiring man-hours can be largely saved, the erroneous wiring can be prevented, and an alignment space of the electronic parts can be reduced, so that the provision of the metal plate can contribute to a size reduction of the discharge lamp lighting unit 17. The metal plate 36 is coupled to the surface mounting substrate 30 via a flexible conductor such as a wire made of gold or aluminum, a ribbon made of metal, or the like.

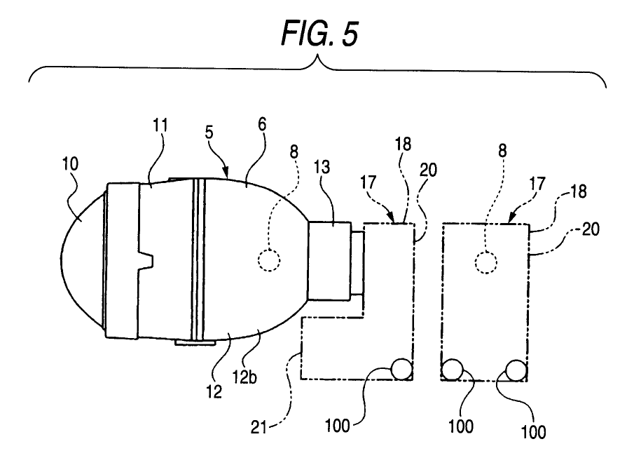

The switching element 31 mounted on the surface mounting substrate 30 is the largest heat generating body in the lighting circuit portion 19. The discharge lamp 8 is the largest heat generating body in the vehicle lighting equipment 1. The switching element 31 is arranged in a position that is separated from the discharge lamp 8, and advantageously in a position that is as far away as possible from the discharge lamp 8, i.e., any one of corner portions 100, 100 on the rear end portion in the lower end portion of the case body 18, as shown in FIG.5, respectively in the interior of the case body 18.

In this manner, the switching element 31 as the largest heat generating body in the lighting circuit portion 19 is arranged in a position that is most distant from the discharge lamp 8, which is the largest heat generating body in the vehicle lighting equipment 1. Therefore, the influence of the heat generated in the discharge lamp 8 upon the switching element 31 can be suppressed to the lowest minimum.

Also, the surface mounting substrate 30 on which the switching element 31 is mounted is arranged in a state that the surface mounting substrate 30 surface-contacts the bottom surface portion 18a made of the metal material. Therefore, an improvement of the radiation performance of the heat generated in the surface mounting substrate 30 and respective electronic parts such as the switching element 31 mounted on the surface mounting substrate 30, etc. and respective electronic parts coupled to the surface mounting substrate 30 via the metal plate 36 can be attained, and also an improvement of reliability of the operation of the lighting circuit portion 19 can be attained.

The bottom surface portion 18a of the case body 18 is formed of the metal material is shown by way of example. Alternatively, portions except the bottom surface portion 18a of the case body 18 may also be formed of the metal material to attain an improvement of the radiation performance or the overall case body 18 may be formed of the metal material to attain an improvement of the radiation performance.

Also, an alignment position of the surface mounting substrate 30 is not limited to the bottom surface portion 18a of the case body 18. The surface mounting substrate 30 may be arranged in the case body 18 in a state that the surface mounting substrate 30 surface-contacts the front surface or the side surface of the projection portion 21 or the side surface or the rear surface of the main body portion 20. In this case, it is advantageous if the portion of the case body 18 on which the surface mounting substrate 30 is arranged is formed of the metal material to ensure the good radiation performance.

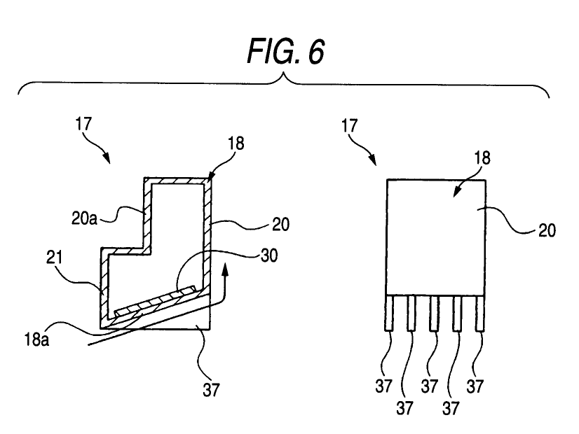

Also, as shown in FIG.6, the bottom surface portion 18a of the case body 18 may be inclined back-upwardly in the horizontal direction and radiating fins 37 may be provided on the bottom surface portion 18a to protrude downward. Thus, a convection of a cooling air is generated on the lower surface side of the case body 18 by inclining the bottom surface portion 18a in this manner, and a radiating area is increased by providing the radiating fins 37. Therefore, an improvement of the radiation performance of the heat generated in the lighting circuit portion 19 can be attained much more.

As described above, in the vehicle lighting equipment 1 according to an exemplary embodiment of the present invention, the projection portion 21 protruded forward from the main body portion 20 is provided in the case body 18 of the discharge lamp lighting unit 17, the projection portion 21 is constructed such that the projection portion 21 is positioned in the space 14 of the lighting chamber 4, and a part of the lighting circuit portion 19 is arranged in the projection portion 21. Therefore, effective utilization of an alignment space of the discharge lamp lighting unit 17 can be achieved, and the downsizing of the vehicle lighting equipment 1, particularly, the slimming down in the longitudinal direction can be achieved.

Also, a position of a center of gravity of the discharge lamp lighting unit 17 comes closer to a connection position of the socket 7 and the case body 18 by arranging the projection portion 21 of the case body 18 in the space 14. Thus, it is more difficult to produce an angular moment around the connection position in the discharge lamp lighting unit 17. Therefore, it is more difficult for a vibration to occur in the vehicle lighting equipment 1 during the running of the vehicle, and a good light distribution characteristic of the light that is emergent from the discharge lamp 8 can be ensured.

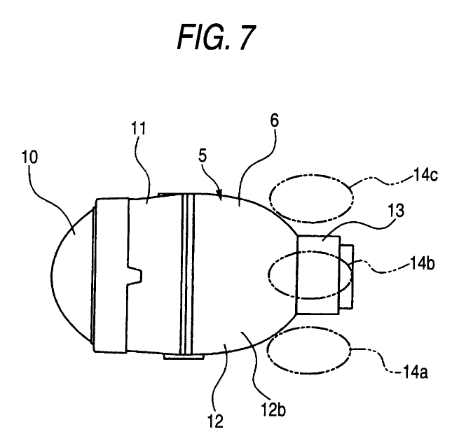

Also, as shown in FIG.7, the projection portion 21 is arranged in a lower portion 14a of the space 14. Therefore, the projection portion 21 is arranged in the portion of the space 14 where a temperature is low, and the influence of heat on the lighting circuit portion 19 can be reduced.

The projection portion 21 of the case body 18 is arranged in the lower portion 14a of the space 14 by way of example. However, any position in the space 14 may be set as the alignment position of the projection portion 21. For example, the case body 18 may be formed such that the projection portion 21 is arranged in a left or right portion 14b or an upper portion 14c in the space 14. Also, the case body 18 may be formed such that two projection portions 21, 21 are arranged on the left and right portions 14b, 14b or the upper portion 14c and the lower portion 14a in the space 14 respectively.

For example, when two projection portions 21, 21 are arranged on the left and right portions 14b, 14b in the space 14 respectively, a part of the lighting circuit portion 19 can be arranged on the two projection portions 21, 21 respectively, and an alignment space of the discharge lamp lighting unit 17 can be utilized more effectively. Therefore, a size reduction of the vehicle lighting equipment 1 can be attained. In this case, when two projection portions 21, 21 are arranged on the left and right portions 14b, 14b in the space 14 respectively, it is advantageous if respective portions of the lighting circuit portion 19 are arranged to keep the lateral balance of the discharge lamp lighting unit 17.

In addition to the vehicle lighting equipment 1 of a type that the discharge lamp 8 is coupled to the holding projection 13 from the rear, exemplary embodiments of the present invention can be applied to the vehicle lighting equipment of a type that the discharge lamp is coupled from the side.

In the discharge lamp lighting unit according to exemplary embodiments of the present invention, at least a part of parts comprising the lighting circuit portion is arranged in the projection portion that is positioned in vicinity of the reflector.

According to exemplary embodiments of the present invention, effective utilization of an alignment space of the discharge lamp lighting unit can be achieved, and the downsizing of the vehicle lighting equipment, particularly, the slimming down in the longitudinal direction can be achieved.

According to exemplary embodiments of the present invention, the influence of the heat on the parts of the lighting circuit portion that is arranged in the projection portion positioned under the discharge lamp can be suppressed to the lowest minimum, and the influence of the heat generated in the discharge lamp upon the switching element can be suppressed to the lowest minimum. Also, an improvement of the radiation performance of the heat generated in parts of the lighting circuit portion mounted on the surface mounting substrate can be attained by radiating the heat from the metal material via the surface mounting substrate.

According to exemplary embodiments of the present invention, if fins are provided to the case body, a convection of a cooling air is generated on the lower surface side of the case body, and thus an improvement of the radiation performance of the heat generated in the lighting circuit portion can be attained.

According to exemplary embodiments of the present invention, a part of parts comprising the lighting circuit portion and the surface mounting substrate are coupled electrically mutually via a metal plate. Therefore, an improvement of the radiation performance of the heat can be attained.

According to exemplary embodiments of the present invention, the discharge lamp is attached detachably to the socket. Therefore, the discharge lamp can be removed from the socket as the case may be, and an improvement of maintainability can be attained.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. A discharge lamp lighting unit arranged on an outer surface side of a reflector provided in a vehicle lighting equipment to reflect an emergent light from a discharge lamp in a predetermined direction, the discharge lamp lighting unit comprising:
a case body comprising a fitting surface portion to which the discharge lamp or a socket for coupling the discharge lamp is fitted, and a projection portion which projects from the fitting surface portion toward the discharge lamp side in a direction in which the discharge lamp or the socket is fitted, the projection portion being positioned in a vicinity of the reflector; and
a plurality of lighting circuit components arranged in the case body, for lighting the discharge lamp;
wherein at least one of the plurality of the lighting circuit components is arranged in the projection portion.

2. A discharge lamp lighting unit according to claim 1, further comprising a surface mounting substrate,
wherein the plurality of lighting circuit components comprises a switching element; a power supplying portion which supplies power, which is obtained by converting an input DC voltage into another voltage by switching the switching element, to the discharge lamp; a controlling portion which controls the power supplied from the power supplying portion to the discharge lamp; and a high-voltage generating portion which generates a high voltage in the discharge lamp to light the discharge lamp,
the projection portion of the case body is arranged on a lower side of the discharge lamp or the socket,
the at least one of the lighting circuit components is provided on the surface mounting substrate,
the switching element is mounted on the surface mounting substrate and arranged in a position in the case body that is a maximum distance away from the discharge lamp, and
at least a portion of the case body on which the surface mounting substrate is arranged is formed of a metal material.

3. A discharge lamp lighting unit according to claim 2, wherein the surface mounting substrate is arranged on a bottom surface portion of the case body, and
the bottom surface portion of the case body is inclined with respect to a horizontal direction.

4. A discharge lamp lighting unit according to claim 2, further comprising a metal plate,
wherein the surface mounting substrate and the at least one of the lighting circuit components are coupled together electrically via the metal plate.

5. A discharge lamp lighting unit according to claim 1, wherein the socket is fitted to the fitting surface portion of the case body and the discharge lamp is detachably attached to the socket.

6. A discharge lamp lighting unit for lighting a discharge lamp, the discharge lamp lighting unit comprising:
a case body comprising a fitting portion and a projection portion, the fitting portion and the projection portion arranged in an L-shaped configuration, the discharge lamp being coupled to the discharge lamp lighting unit at the fitting portion of the case body, and the projection portion projecting in the emergent light direction alongside of the discharge lamp; and
a plurality of lighting circuit components, at least one of the lighting circuit components being arranged in the projection portion.

7. The discharge lamp lighting unit according to claim 6, further comprising:
a surface mount substrate provided along a portion of the case body; and
a metal plate,
wherein the plurality of lighting circuit components are electrically coupled to the surface mount substrate via the metal plate.

8. A vehicle headlamp comprising:
a lamp unit comprising:
a discharge lamp which emits light,
a reflector which reflects the light from the discharge lamp in an emergent light direction, and
a holding projection which is provided at an end of the reflector at which the discharge lamp is mounted; and
a discharge lamp lighting unit comprising:
a case body comprising a fitting portion and a projection portion, the discharge lamp being coupled to the discharge lamp lighting unit at the fitting portion of the case body, and the projection portion projecting in the emergent light direction alongside of the holding projection of the lamp unit; and
a plurality of lighting circuit components, at least one of the lighting circuit components being arranged in the projection portion.

9. The vehicle headlamp according to claim 8, wherein the discharge lamp lighting unit further comprises:
a surface mount substrate provided along a portion of the case body; and
a metal plate,
wherein the plurality of lighting circuit components are electrically coupled to the surface mount substrate via the metal plate.
